(19) United States
(12) Patent Application Publication
(10) Pub. No.: US 2006/0279915 A1
(43) Pub. Date: Dec. 14, 2006

(54) Image apparatus with improved hinge structure

(75) Inventor: Dong-seok Lee, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/326,193

(22) Filed: Jan. 6, 2006

(30) Foreign Application Priority Data
Jun. 14, 2005 (KR) 2005-50739

(51) Int. Cl. G06F 1/16

(52) U.S. Cl. 361/681

(57) ABSTRACT

An image apparatus has a main body with a seating portion that is recessed by a predetermined depth from an outer surface of the main body. A display unit that has a display part is pivotably mounted to the main body by a hinge unit. The seating portion has a mounting hole formed on a side of the seating portion to help insertion of the hinge unit into the main body. This structure of the hinge unit improves the appearance of the image apparatus.

### CROSS-REFERENCE TO RELATED APPLICATIONS

This application claims the benefit under 35 U.S.C. § 119(a) of Korean Patent Application No. 2005-50739, filed Jun. 14, 2005, the entire contents of which are hereby incorporated by reference.

### BACKGROUND OF THE INVENTION

1. Field of the Invention

The present invention relates to an image apparatus. More particularly, the present invention relates to an image apparatus in which a display unit for showing an image is pivotably mounted to a main body of the image apparatus.

2. Description of the Related Art

Typical image apparatuses such as camcorders are capable of recording an image of an object being photographed on a recording medium such as tape, a hard disc, or a compact disc (CD), and reproducing the recorded image. Therefore, the image apparatuses are generally equipped with a display unit (which is separate from a view finder through which objects may be observed) to display the image being photographed or reproduced.

The display unit usually pivots on one side of a main body of the image apparatus. More specifically, the display unit pivots like a door so that is can be closed by being seated on one surface of the main body and opened by being separated from the surface. A seating part having a shape corresponding to the display unit is formed on the surface of the main body to receive the display unit in a closed state.

The display unit includes a hinge unit at one side to support the pivoting movement of the display unit. The hinge unit is usually mounted inside the main body so that it cannot be seen from outside the main body to improve the appearance of the image apparatus.

The main body has a few holes to mount the hinge unit. The shape and location of the mounting holes affects the aesthetic appearance of the image apparatus. Furthermore, if a dedicated cover member is added to cover the mounting holes, the number of parts increases. This also affects the aesthetic appearance of the image apparatus, and makes assembly more difficult and costly.

Accordingly, there is a need for an image apparatus with an improved structure for mounting a hinge unit in an aesthetically pleasing manner.

### SUMMARY OF THE INVENTION

An aspect of the present invention is to address at least the above problems and/or disadvantages and to provide at least the advantages described below. Accordingly, an aspect of the present invention is to provide an image apparatus having an improved structure for mounting a hinge unit.

In accordance with an aspect of the present invention, an image apparatus comprises a main body with a seating portion that is recessed by a predetermined depth from an outer surface of the main body. A display unit that has a display part is pivotably mounted to the main body. A hinge unit pivotably connects the display unit to the main body. The seating portion has a mounting hole formed on its side to facilitate insertion of the hinge unit into the main body.

According to an exemplary embodiment of the present invention, the hinge unit supports the display unit so that it can be pivoted independently about an x-axis and a y-axis (which are substantially perpendicular to each other).

The hinge unit may comprise a main bracket, a first hinge part connected to the main bracket to support pivoting of the display unit on the x-axis, and a second hinge part fixed to the main body and pivotably connected to the main bracket to support pivoting of the main bracket on the y-axis.

The hinge unit may further comprise a housing that receives and encloses the main bracket.

The mounting hole may be configured so that the housing and the second hinge part can pass therethrough in a predetermined posture.

The image apparatus may further comprise a guide unit that guides fastening of the hinge unit being passed through the mounting hole and inserted in the main body.

The guide unit may comprise at least one guide rib formed inside the main body to guide the position of the hinge unit being fastened with the main body, and at least one guide boss fixing the position of the hinge unit as guided by the guide rib to the main body.

The image apparatus may further comprise a cover that protects the hinge unit by covering a rest area of the mounting hole, after connection of the hinge unit to the main body.

The x-axis may refer to a reference axis that is substantially perpendicular to a bottom of the seating portion while the y-axis may refer to a reference axis that is substantially parallel with the bottom.

The hinge unit may be inserted in the mounting hole when the display unit is substantially parallel to the x-axis.

The mounting hole may extend from the side of the seating portion to an outer surface of the main body.

### BRIEF DESCRIPTION OF THE DRAWING FIGURES

The above and other objects, features, and advantages of certain exemplary embodiments of the present invention will be more apparent from the following description taken in conjunction with the accompanying drawings, in which:

FIG. 1 is a perspective view of an image apparatus according to an exemplary embodiment of the present invention;

FIG. 2 is an exploded, perspective view of the image apparatus of FIG. 1;

FIG. 3 is a perspective view showing certain elements of the hinge unit of FIG. 2;

FIG. 4 is a perspective view showing the image apparatus of FIG. 1 from a different angle, with the cover removed;

FIG. 5 is a perspective view of the image apparatus of FIG. 4, with the cover attached; and

FIG. 6 is a sectional view cut along the line VI-VI in FIG. 5.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the exemplary embodiments of the invention. Accordingly, those of ordinary skill in the art will recognize that various changes and modifications of the exemplary embodiments described herein can be made without departing from the scope and spirit of the invention. Also, descriptions of well-known functions and constructions are omitted for clarity and conciseness.

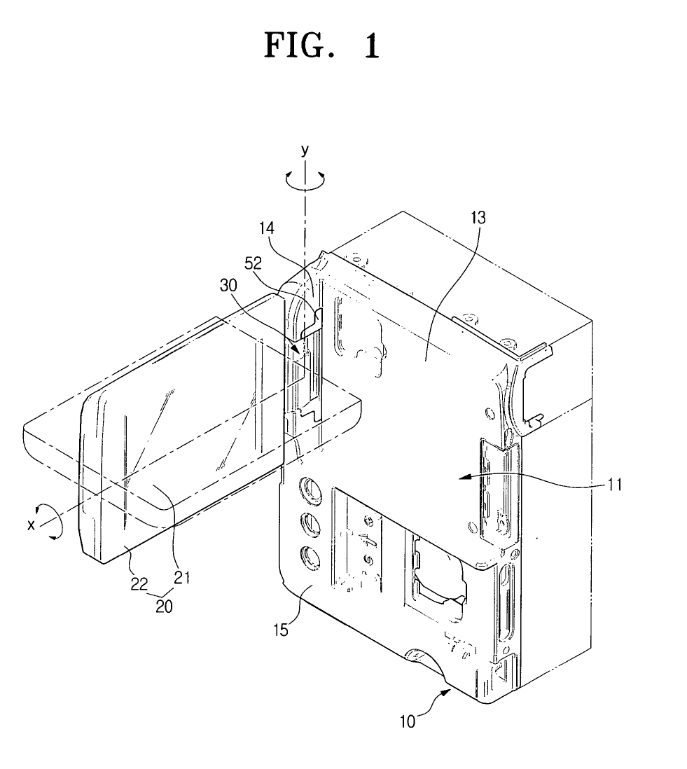

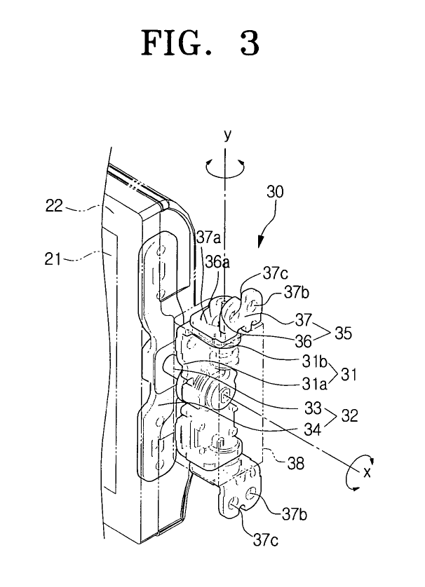

As shown in FIGS. 1 through 6, the image apparatus according to an exemplary embodiment of the present invention comprises a main body 10, a display unit 20, a hinge unit 30, a guide unit 40, and a cover 50.

The main body 10 has a seating portion 11 to receive the display unit 20 which will be described in detail later. The seating portion 11 is formed as a recess having a predetermined depth from a surface of the main body 10 and has a shape that corresponds to the display unit 20.

A mounting hole 12 is formed on a side 14 of the seating portion 11 to mount the hinge unit 30 inside the main body 10. The mounting hole 12 extends from the side 14 of the seating portion 11 to an outer surface 15 of the main body 10, such that the hinge unit 30 can pass through the mounting hole 12 at a predetermined position. In other words, the mounting hole 12 is formed through the side 14 of the seating portion 11 and the outer surface 15 of the main body 10, rather than on a bottom 13 of the seating portion 11.

The main body 10 may include a camera unit for obtaining image data (not shown), a view finder for a user to directly check the image data, a recording/reproducing device for storing and reproducing the image data, and a recording medium. Since these components are well known to those skilled in the art, a detailed description is omitted for brevity.

The display unit 20 comprises a display part 21 and a frame part 22 that supports the display part 21. The display part 21 shows the image data being photographed by the camera unit (not shown) or the image data being reproduced, that has been stored in the recording medium (not shown). A liquid crystal display (LCD) is generally used for the display part 21.

The hinge unit 30 pivotably connects the display unit 20 to the main body 10. More specifically, the hinge unit 30 supports the display unit 20 so that it can independently pivot about the x-axis and y-axis. To this end, the hinge unit 30 comprises a main bracket 31, a first hinge part 32, a second hinge part 35, and a housing 38.

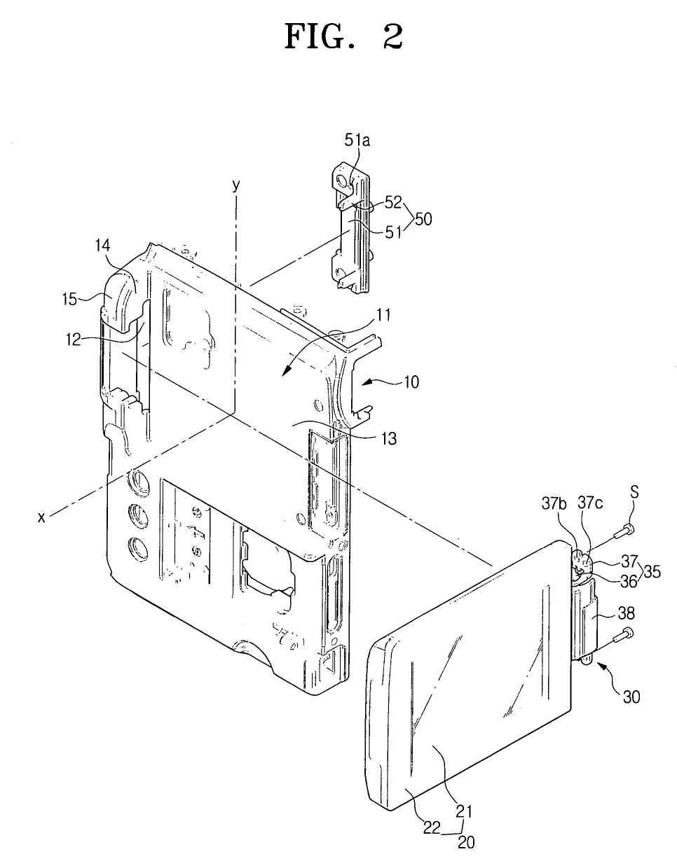

As shown in FIGS. 1 and 2, the x-axis, which is the reference axis for pivoting of the display unit 20, is substantially perpendicular to the bottom 13 of the seating portion 11 of the main body 10, whereas the y-axis is substantially parallel with the bottom 13. That is, the x-axis and the y-axis cross each other at substantially right angles.

The main bracket 31 supports the first and the second hinge parts 32 and 35. The main bracket 31 comprises a first support part 31a that supports the first hinge part 32 and a pair of second support parts 31b that are bent and extend from the opposite ends of the first support part 31a to support the second hinge parts 35.

The first hinge part 32 is connected to the main bracket 31 to support pivoting of the display unit 20 in the x-axis direction. The first hinge part 32 comprises a first hinge shaft 33 and a connection bracket 34.

The first hinge shaft 33 is inserted in the first support part 31a of the main bracket 31 in the x-axis direction. The connection bracket 34 is connected to one end of the first hinge shaft 33 which is inserted in the main bracket 31. The connection bracket 34 is fastened to the frame part 22 of the display unit 20 by a fastener, which may be a screw, for example. Therefore, the first hinge part 32 allows the display unit 20 to pivot on the x-axis, as shown in FIG. 1.

The second hinge part 35 is fixed to the main body 10 of the image apparatus and supported by the main bracket 31 to pivot on the y-axis. To this end, the second hinge part 35 comprises a pair of second hinge shafts 36 and a hinge bracket 37.

The pair of second hinge shafts 36 are inserted in the pair of second support parts 31b of the main bracket 31, respectively, and thereby pivotably supported. In addition, a guide projection 36a formed on the second hinge shaft 36 guides pivoting of the second hinge shaft 36 with respect to the hinge bracket 37.

One side of the hinge bracket 37 has a guide groove 37a, and the other side of the hinge bracket 37 has first and second fastening holes 37b and 37c. The sides of the hinge bracket are bent towards each other; that is, they form an angled portion.

The guide projection 36a is inserted into the guide groove 37a and guides the pivoting range of the guide projection 36a with respect to the y-axis. The first fastening hole 37b is formed to fix the hinge bracket 37 onto the main body 10 with a fastener, such as a fastener S. The second fastening hole 37c is formed to fix both the hinge bracket 37 and the cover 50 to the main body 10 with a fastener, such as a fastener S.

With the above structure, the display unit 20 is able to pivot on the y-axis, as shown in FIG. 1, because of the second hinge part 35.

While pivoting on the y-axis, the display unit 20 can move between a seated position where the display part 21 is received in the seating portion 11 and thereby closed and an open position where the display part 21 is separated from the seating portion 11 and thereby opened.

The housing 38 receives and encloses the main bracket 31. Also, the housing 38 receives the first and the second hinge shafts 33 and 36 that are respectively supported by the main bracket 31. Therefore, only the hinge bracket 37 which is connected to the second hinge shaft 36 of the second hinge part 35 is exposed outside the housing 38.

The housing 38 of the hinge unit 30 and the hinge bracket 37 of the second hinge part 35 are connected to the inside of the main body 10, passing through the mounting hole 12. Here, as shown in FIG. 2, the mounting hole 12 is configured to enable the housing 38 and the hinge bracket 37 to be inserted therein in a state that the display unit 20 is substantially parallel with the x-axis. In other words, the mounting hole 12 is formed by penetrating the side 14 of the seating portion 11 and the outer surface 15 of the main body 10, such that the hinge bracket 37 and the housing 38 are inserted in the x-axis direction.

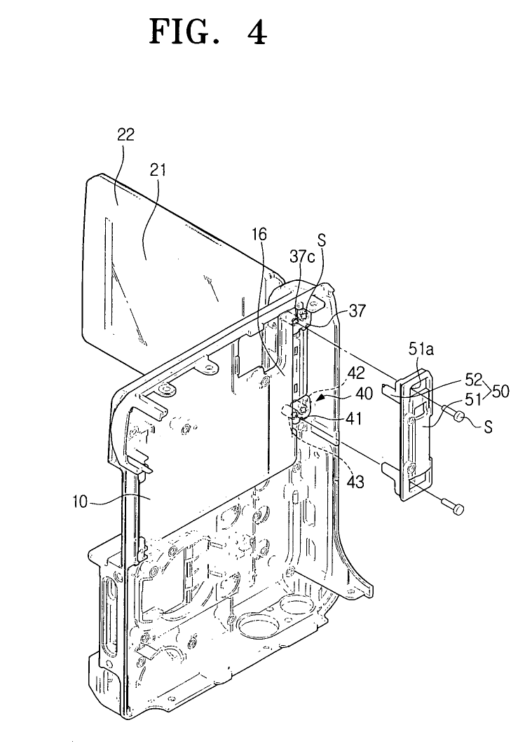

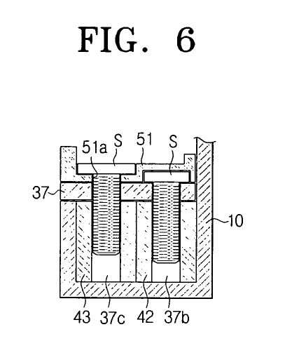

The guide unit 40 guides the hinge unit 30 as it is passed through the mounting hole 12 and inserted in the main body 10, as shown in FIGS. 4 and 6. To do this, the guide unit 40 comprises at least one guide rib 41 and first and second guide bosses 42 and 43.

As shown in FIG. 4, the guide rib 41 is formed on an inner surface 16 of the main body 10 so as to guide the position of the hinge unit 30 being fastened to the main body 10. In an exemplary embodiment, a pair of the guide ribs 41 are provided to contact the corner edges of the pair of hinge brackets 37.

The first and the second guide bosses 43 and 44 fasten the hinge unit 30 onto the main body 10, as shown in FIG. 6. The first and the second guide bosses 43 and 44 are engaged with the fasteners S that pass through the first and the second fastening holes 37c, respectively.

The cover 50, as shown in FIG. 4, shields a rest area of the mounting hole 12, after the hinge unit 30 is fastened to the main body 10, to protect the hinge unit 30. To this end, the cover 50 comprises first and second cover parts 51 and 52.

As shown in FIGS. 4 and 6, the first cover part 51 is inserted in the mounting hole 12 to shield the housing 38 and the pair of hinge brackets 37 as inserted in the main body 10. Here, the first cover part 51 has a fixing hole 51a for insertion of the fastener S, to correspond to the second guide boss 43. As shown in FIG. 6, the fastener S inserted in the fixing hole 51a penetrates the second fastening hole 37c of the hinge bracket 37, thereby being engaged with the second guide boss 43.

The second cover part 52 protrudes from the first cover part 51. As shown in FIGS. 1 and 2, the second cover part 52 shields the rest area of the mounting hole 12, formed at the side 14 of the seating portion 11, thereby protecting the hinge bracket 37.

The assembly of the image apparatus according to an exemplary embodiment of the present invention will be described with reference to FIGS. 1 to 6.

As shown in FIG. 2, the hinge unit 30 is pivotably mounted on one side of the display unit 20 and is substantially parallel with the x-axis. The hinge unit 30 is inserted in the mounting hole 12 while maintaining the display unit substantially parallel to the x-axis. As shown in FIG. 4, the pair of guide ribs 41 formed on the inner surface 16 of the main body 10 guide the position of the hinge unit 30 while it is being fastened to the main body 10.

Next, as shown in FIG. 6, the hinge unit 30 is fixed to the main body 10 by fastening the fastener S with the first guide boss 42 through the first fastening hole 37b of the hinge bracket 37. Accordingly, the display unit 20 is mounted to pivot with respect to the x-axis and the y-axis on the first and the second hinge parts 32 and 35, independently, as shown in FIG. 1.

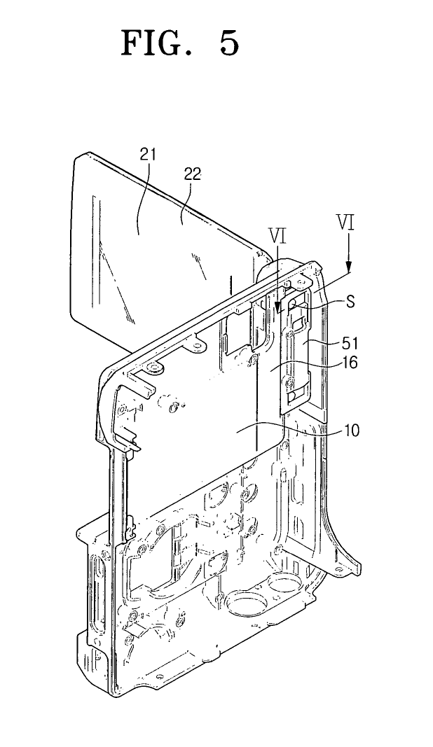

As shown in FIG. 4, the cover 50 is inserted in the main body 10 to protect the hinge unit 30 and covers the rest area of the mounting hole 12 at the same time. More specifically, as shown in FIG. 5, the first cover part 51 covers the rest area of the mounting hole 12, at the inner surface 16 of the main body. As shown in FIG. 1, on the other hand, the second cover part 52 covers the rest area of the side 14 of the seating portion 11. The cover 50 sequentially passes through the fixing hole 51a and the second fastening hole 37c of the hinge bracket 37, thereby being fixed to the main body 10 by the fastener S fastened with the guide boss 43.

According to the above structure, the mounting hole 12 is configured to correspond to the housing 38 and the second hinge part 35 of the hinge unit 30 so that the hinge unit can be inserted substantially parallel with the x-axis. Therefore, the size of the mounting hole 12 can be minimized, thereby improving the aesthetic qualities of the image apparatus.

Furthermore, according to an exemplary embodiment of the present invention, furthermore, the assembly of the display unit 20 supported by the hinge unit 30 is easier.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. An image apparatus comprising:
a main body including a seating portion recessed by a predetermined depth from an outer surface of the main body;
a display unit pivotably mounted to the main body; and
a hinge unit pivotably connecting the display unit to the main body,
wherein the seating portion has a mounting hole formed on a side to facilitate insertion of the hinge unit into the main body.

2. The image apparatus of claim 1, wherein
the hinge unit pivotably supports the display unit so that it can be independently pivoted about an x-axis and a y-axis that are substantially perpendicular to each other.

3. The image apparatus of claim 2, wherein
the x-axis is substantially perpendicular to a bottom of the seating portion, and
the y-axis is substantially parallel to the bottom of the seating portion.

4. The image apparatus of claim 3, wherein the hinge unit comprises:
a main bracket;
a first hinge part connected to the main bracket to support pivoting of the display unit on the x-axis; and
a second hinge part fixed to the main body and pivotably connected to the main bracket to support pivoting of the main bracket on the y-axis.

5. The image apparatus of claim 4, wherein
the hinge unit further comprises a housing that receives and encloses the main bracket.

6. The image apparatus of claim 5, wherein
the mounting hole is configured so that the housing and the second hinge part can pass through the mounting hole in a predetermined position.

7. The image apparatus of claim 6, wherein
the hinge unit can be inserted in the mounting hole when the display unit is positioned substantially parallel with the x-axis.

8. The image apparatus of claim 7, wherein
the mounting hole extends from the side of the seating portion to an outer surface of the main body.

9. The image apparatus of claim 1, further comprising
a guide unit that guides fastening of the hinge unit being passed through the mounting hole and inserted in the main body.

10. The image apparatus of claim 9, wherein the guide unit comprises:
at least one guide rib formed inside the main body to guide a position of the hinge unit being fastened with the main body; and
at least one guide boss fixing the position of the hinge unit to the main body.

11. The image apparatus of claim 1, further comprising
a cover that protects the hinge unit by covering a rest area of the mounting hole, after connection of the hinge unit to the main body.

12. An image apparatus comprising:
a main body with an outer surface;
a seating portion formed in the outer surface of the main body, the seating portion having a bottom and a side, the side having a mounting hole that extends through the seating portion to the outer surface of the main body;
a display unit; and
a hinge unit mounted in the mounting hole, the hinge unit pivotably connecting the display unit to the main body,
wherein the mounting hole is configured to enable the hinge unit to be inserted into the mounting hole when the display unit is substantially perpendicular to the bottom of the seating portion.

13. The image apparatus of claim 12, wherein
the hinge unit allows the display unit to independently pivot about a first axis and a second axis.

14. The image apparatus of claim 13, wherein
the first axis is substantially perpendicular to a bottom of the seating portion, and
the second axis is substantially parallel to the bottom of the seating portion.

15. The image apparatus of claim 14, wherein the hinge unit comprises:
a main bracket;
a first hinge part connected to the main bracket to support pivoting of the display unit about the first axis; and
a second hinge part fixed to the main body and pivotably connected to the main bracket to support pivoting of the main bracket about the second axis.

16. The image apparatus of claim 15, wherein
the hinge unit further comprises a housing that encloses the main bracket.

17. The image apparatus of claim 12, further comprising
a guide unit that guides the hinge unit as it is passed through the mounting hole and inserted into the main body.

18. The image apparatus of claim 17, wherein the guide unit comprises:
at least one guide rib formed inside the main body to guide the hinge unit as it is fastened with the main body; and
at least one guide boss for fixing the hinge unit to the main body.
